(19) United States
(12) Patent Application Publication
(10) Pub. No.: US 2020/0265447 A1
(43) Pub. Date: Aug. 20, 2020

(54) Process and Automated System for Discovering and Optimizing Leadership and Constituency Correlations to Increase Participation and Sustainability for Election Outcomes of Governments and Other Organizations

(71) Applicant: David Langley Kent, Antiocha, CA (US)

(72) Inventor: David Langley Kent, Antiocha, CA (US)

(21) Appl. No.: 16/280,382

(22) Filed: Feb. 20, 2019

(51) Int. Cl. G06Q 30/02; G06N 20/00

(52) U.S. Cl. CPC G06Q 30/0201; G06N 20/00

(57) ABSTRACT

A conceptual approach to election reform for governments and other institutions, a regular process for a number of embodiments, and an online system for a practical embodiment that greatly improves the effectiveness of Leadership and morale of the Constituency, thereby increasing social productivity, participation and stability at any scale. It requires no legal enforcement to function and can be deployed entirely on a voluntary basis. It works with many political systems and governmental structures, offering a high degree of configurability for Sponsors to adjust operations to best fit standards, practices and intentions of regions or communities. The invention is distinguished from prior art by promoting the pre-election stage to dominance over ceremonial ratification and mining the personae of Leaders and Constituents to overcome information loss inherent in the plain binary vote, for the purpose of introducing intelligent recommendations into the process and structure of institutions that can improve election outcomes.

### BACKGROUND OF THE INVENTION

### Field of Endeavor

Utilizing the arts of Data Science and Internet Technologies, the invention reveals Leadership-Constituency correlations and applies optimizations to an election process for any type of organization, helping assure accurate and continuous representation for both sides that can sustain beyond an official ratification. Based on observations from Political Science and Psephology, the relevant technologies can be employed to select candidates, assign roles, advise reporting structure and align sentiments with constituencies by overcoming inherent restrictions in the way representation is currently counted and considered by conventional political and corporate systems.

### Background of the Prior Art

The invention is distinct from and superior to the prior art because organizations traditionally operate on the basis of no representation, unequal representation with special dispensation for the privileged, or a binary “1-person, 1-vote” tally which restricts the meaning and full potential of representation itself. The invention enriches knowledge about representation for both Leaders and their Constituencies in order to produce persistent reforms and advancements with less danger of collateral damage erupting from mutual disregard, unremedied conflict, violent corrections and backlash.

The invention inquires of a Constituent: “What makes up your self-concept as a member of this organization which would incentivize you to vote “yes”, “no” or abstain in an election?” and of a Leader: “What makes up your self-concept as a Leader of this organization which would incentivize you to campaign or withdraw your candidacy in an election?” This information is collected and processed into personae profiles before ratification and utilized to recommend optimal candidates, assign roles, and recommend policies that would best facilitate progress, mutual support, participation and morale for all involved.

By contrast, the prior art treats voters who abstain or candidates who drop out of a race as constituting total information loss, as if no representation or Leadership opportunities were ever offered. The prior art counts those who participate on the basis of a binary “yes”/“no” vote, with winner-take-all “yes” votes interpreted as a mandate. The true motivations, personalities and inclinations of Leaders and voters are thereby disregarded, compromising any assurance of accurate representation. Widespread cynicism, opposition to essential change, suppression of healthy conflict through disregard for losers, volatility, backlash, scandal and improperly enacted initiatives of a kleptocratic majority arise consistently in the prior art. At the root of the problem, a simple “yes/no” vote says nothing about “why?”

During the Memphis Sanitation Strike of 1968 the famous phrase: “I Am a Man” was coined (https://www.smithsonianmag.com/history/revisitin-sanitation-workers-strike-180967512). This elemental statement implies the eligibility of all persons to be granted empathy and freedom to pursue their unrestricted potential for assisting the cause of civilization, for their own benefit and the benefit of others. When many of “I, a person” comprises “We, the people” the quality of each individual contribution multiplies to improve the success of the aggregate. The claims and several embodiments contained herein arise from this observation. In summary:

1. A process by which the formation of public or private governmental bodies of all types—populist, democratic, republican, oligarchical, monarchistic and others—can be enhanced and reinstituted to multiply productivity, wealth and unity while avoiding destructive corrections that inevitably arise from unremedied conflict; and
2. A software system to implement this process online utilizing Data Science and Internet Technologies.

These embodiments require no legal mandate or dispensation to function and produce the desired effect; they may be implemented entirely on a voluntary basis and according to a wide range of parameters that align with regional and community standards, traditions, legacies, and established political systems.

Our collective defense against natural law, embodied within civilizations, is best facilitated by specialization and standardization. By these means, individuals may concentrate on producing higher quality original work to be integrated into a collective endeavor by employing regular processes and agreements. However, if individuals must also specialize in the collaborative arts, such as operations theory, supply chain management, government and commerce this can interfere with their preferred level of concentration. Therefore, trustworthy processes and agreements must be formed for the sake of our collective efficiency. Otherwise, if the farmer, the machinist and the pharmacist all bring their wares to a market and attempt to coordinate, expand and distribute their integrated products independently a deadlock may ensue. The idealized role of government and industry is to leverage contracts between individuals toward an ever-increasing level of abstraction, scale and generality. This action facilitates commerce and technical advancement, which in turn improve the quality of existence in a civilized setting.

The ability for societies to promote individuals with suitable skills and integrity into roles of decisive authority and reduce the number of “bad hires” produced by seemingly equitable political systems is therefore an imperative. The means by which the most effective Leadership can be produced holds to the concept of representation, which implies that a maximum level of understanding on both sides must be continually sought. In other words, the constituency must be accurately represented to the Leadership and vise-versa. The “1 person, 1 vote” tally upon which conventional elections are based, though conceptually fair and based on majority rule, is intrinsically inadequate for the purpose of obtaining a requisite degree of mutual understanding. In fact, the binary “aye/nay” winner-take-all distinction is the most extreme form of over-approximation resulting in maximum information loss. An individual should be regarded as far more than a “swinging chad” in order to be properly counted. (“Chads” were made controversial and ridiculous to some during the Florida 2000 Presidential election recount case, which was elevated to the level of the Supreme Court of the United States before a resolution was reached, https://www.britannica.com/event/Bush-v-Gore). The frequency and sustainability of advancements or reforms arising from such a single-chad system are inherently restricted. Therefore, all civilized systems employing conventional electoral processes will suffer a shortfall of potential.

The futility of conventional social systems is also caused by a lack of continuous control over their dynamics. Arising from the information loss contained by the binary counting of representation and resulting in escalations of conflict, these systems tend to collapse into lurching corrections, backlashes and violence, with collateral damage being perpetrated indiscriminately upon the innocent. If a judicious measure of intelligent and continuous correction can be applied to political systems then “steering off the track” due to lack of a driver may be prevented and a steady course of advancement maintained. It is noted that no effective control mechanism can be devised if the sole inputs are in units of inhabitants having a single “yes/no” form of representation. Some indirect approaches to achieving a form of updated control, such as conducting polls or focus groups, do not sufficiently improve the accuracy of the inputs needed to advise the political process because of bias, skewing and lack of concern for the personae and intentions of the individuals being surveyed. Neither does the tracking of voting records in the legislature supply the requisite detail, because the intended influences of Leaders are more complex and profound than simple tallies taken in parliamentary sessions. An example of lost information incurred by both Constituencies and Leadership is the “why?” of a vote on either side: “Was it the lesser of the evils?”; “Was the voter a long-time supporter or advocate of an individual or policy, or were they in fervent opposition?”; “Did an individual abstain due to an intentional objection or indictment of the process?” Without this degree of mutual understanding on both sides, policy formation proceeds on an uninformed basis until crisis ensues.

If Leadership may be placed under a form of continuous correction, the resultant calibration can facilitate more effective coordination, integration and distribution of individually-produced contributions from the Constituency to be utilized for the collective good. Such improved Leadership takes on the burden of infrastructure, legislation, the public trust and a common defense, among many other responsibilities designed to preserve the general welfare. The prior art does not allow for such processes to be conducted efficiently and symptoms of this shortfall occur in everyday life. For example, the attitude of the citizenry toward Leadership worldwide is traditionally cynical. “The more things change, the more they stay the same”—attributed to Alphonse Karr; “Meet the new boss, same as the old boss”—The Who, from the song title “We Won't Get Fooled Again”. The problem with accepting this negative constancy is that whenever injustice and suffering persist without relief until continuation of the status quo is deemed immoral, persistent and substantive reforms are observed to be few, far between, obtained at great cost, a long time in coming and bringing with them many unforeseen consequences—all of which indicate a problem with efficiency at the Leadership level. Scandal, abberrance and corruption are generally expected from Leaders worldwide and there is widespread objection to the level of privilege and power afforded to those perceived as undeserving.

The prior art also devalues a precious commodity: healthy conflict. In a winner-take-all system the losers are often simply disregarded. This forestalls discoveries of optimal courses of action which can be revealed by continued study, debate and pursuit of elusive “3rd alternatives” in the midst of dilemmas, with a diverse group of individuals and perspectives participating. In a binary system the final choice always rests on one extreme, by definition; it is inherently exclusive.

The prior art does allow for a rotation of extremes over time, but the enacting and repealing of expensive policies is inefficient. Health care reform in the U.S. is one example (https://www.cbo.gov/topics/health-care/affordable-care-act; https://www.washinggtonpost.com/news/powerpost/paloma/the-health-202/2018/09/04/the-health-202-debate-over-future-of-affordable-care-act-begins-anew-this-week/5b8ad86f1b326b3f31919f24/?utm_term=.574b34f71066). This is tantamount to tacit acceptance of the inevitability of repetitious violent corrections and unrest, despite some veneer of moderation which may be imposed by the decorums of tradition.

The prior art also allows for referendums and special elections, which can be partially effective on a populist basis. However, this process is still not efficient as compared to installing well-informed Leadership, since requiring voters to read and absorb multipage ballots with sufficient domain knowledge to make informed decisions is impractical. Furthermore, a referendum still concludes with a “yes/no” tally so that worthy measures die in the populous while wasteful ones become law. No smarter “3rd alternatives” can emerge from such a process.

The deleterious syndromes cited above—constancy where change is morally mandated, eradication of healthy conflict rather than cultivation of diversity and inclusion, toleration of volatility, backlash and scandal, placement of the burden of decision onto a populace when execution would be better performed by experts—all arise from a fundamental disregard for the multidimensional nature of personae that comprise a population deserving of accurate representation.

The invention eliminates the aforementioned syndromes by solving the problem of representation at the basic level, by ascribing many dimensions of personae to each individual in order to ascertain the measurable will of persons in aggregate. Armed with these enhanced units of representation, a more complete and illuminated understanding allows Leaders to be more effectively selected for their roles and made aware of the true nature of their constituencies as they pursue their appointed duties. They can also enjoy increased support and participation from their electorate as a result of subsequent successes.

Mandated change becomes more predictable and continuous when political systems are placed under the control of these informed and intelligent influences, including meaningful advice on topical issues, apropos financial guidelines, accountability for well-defined and consistent Leadership styles, and increased participation by the community. As the system continues to function, each election cycle becomes better informed by a more refined match between representatives and the represented, thereby reducing potential backlash and preserving a steadier pace of advancement with less backtracking.

Healthy conflict is promoted by the mediation of opposing forces that are accurately represented, resulting in more inclusive, diverse and functional governmental structures and operations.

Relegation of appropriate issues to the referendum process can result from improvements in morale and the level of trust among populations. Leaders may call for further rounds of information-gathering to help update their understanding and gauge support for particular proposals and expenditures.

As the invention continues to function and detailed results are published publicly, prevalent worldwide cynicism may begin to subside and general support for effective Leadership may one day become the norm.

In the embodiment of a process (FIG. 1) multiple dimensions of personae which characterize the nature and intentions of the constituency and its Leadership are determined. The information-gathering process is prescribed to be non-judgmental and maximally universal, so as to solicit even extreme responses from individuals, if genuine. The most essential stage of the process occurs during pre-election, avoiding potentially contentious issues of security, eligibility, tradition and protocol that may arise when considering changes to official electoral ratification procedures. In order to accommodate currently existing political systems and their legalities, a wide range of parameters may be expressed that control the operation of the system, such as the number and types of inquiries put to individuals, the phrasing and topical content of issues surveyed, the ability to accept write-in candidates and ad-hoc suggestions for redesigning the election process itself, including the proposed structure of the elected government. Even if never ratified or otherwise adopted, the information gathering and conclusive recommendations offer all participants confirmation that their worth and potential as citizens are being sincerely regarded by the election process. The mere presence of this information, however it may be collected and disseminated, provides its own measure of intrinsic correction and accountability for both sides.

### BRIEF SUMMARY OF THE INVENTION

The invention is a conceptual approach to political and electoral reform for private and public institutions, a regular process for a number of embodiments that can accomplish it, and a software-based online system for a practical embodiment that when applied to a conventional election process greatly improves outcomes by strengthening the effectiveness of Leadership and the confidence of their Constituency, thereby increasing social productivity, participation and stability at any scale.

The invention eliminates many conventionally observed syndromes by solving the problem of representation at the root level, ascribing multiple dimensions of personae to all participants and ascertaining the characteristics and intentions of persons with broad influence to govern, as well as those being represented.

### BRIEF DESCRIPTION OF THE DRAWINGS

Some preferred embodiments of the present invention are illustrated as examples and are not to be considered as limiting its scope with regard to other embodiments, which could be capable of implementing the invention. Accordingly:

FIG. 1 illustrates an embodiment in a diagrammatic representation of the sequence of steps and decisions needed within a software system to complete the process of transforming a single vote into a voter profile and encapsulating information about multiple Leaders, issues and policies.

FIGS. 2, 3 & 4 depict more detailed views of an embodiment of Sponsor specification expressions that define and govern the procedures, structures and policy topics which contribute integrally to the development of the system's conclusions.

FIG. 5 depicts an embodiment of an interface on a personal device for capturing responses to Leadership and Constituent Inquiries in order to create participant profiles.

FIG. 6 expands the responses to Leadership and Constituent Inquiries into a pattern designed to elicit nonjudgmental, objective views about leadership style, which is an elemental factor important to the sustainability of effective representation.

FIG. 7 further expands the responses to Leadership and Constituent Inquiries into a pattern designed to elicit nonjudgmental, objective views about general leadership policies that tend to influence binding decisions.

FIG. 8 depicts an embodiment of Constituent and Leadership Inquires which present the Sponsor's policy topic selections of FIG. 4, possibly including financial plans and expenditures, for guided review and commentary by the constituency.

FIG. 9 depicts an embodiment of Constituent and Leadership Inquires which accepts a write-in candidacy or other form of volunteerism from a participant, allowing a recommendation to form outside of the intent or structure of the original election.

FIG. 10 depicts an embodiment of the Recommendations and Analytics presentation which the system generates, representing the internal conclusions kept for influencing subsequent operational iterations under the auspices of the same Sponsor.

FIG. 11 depicts an embodiment of the World Wide Reporting which may be viewable by the general world audience for comparison, imitation, opposition or other reactions, thereby elevating the world consciousness of the role of governments and industries in society, with possible local correlations. It also represents internal conclusions that may influence subsequent iterations across multiple Sponsors for promoting comity among sectors with common interests.

### DETAILED DESCRIPTION OF THE INVENTION

The terminology used herein is for the purpose of describing particular embodiments only and is not intended to be limiting of the invention. The present disclosure is to be considered as an exemplification of the invention, and is not intended to limit the invention to the specific embodiments.

Unless otherwise defined, all terms (including technical and scientific terms) used herein have the same meaning as commonly understood by one having ordinary skill in the art and technology to which this invention belongs. It will be further understood that terms, such as those defined in commonly used dictionaries, should be interpreted as having a meaning that is consistent with their meaning in the context of the relevant art, technology and the present disclosure, and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

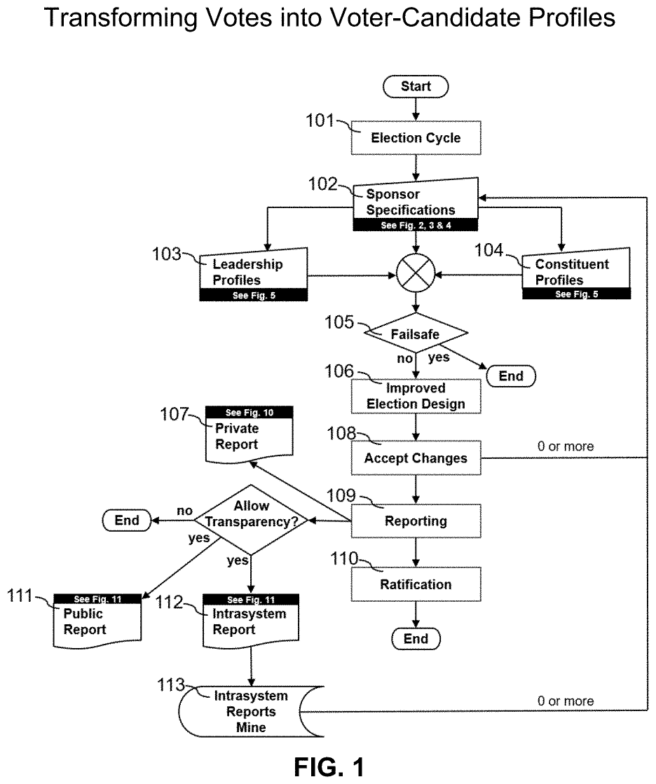

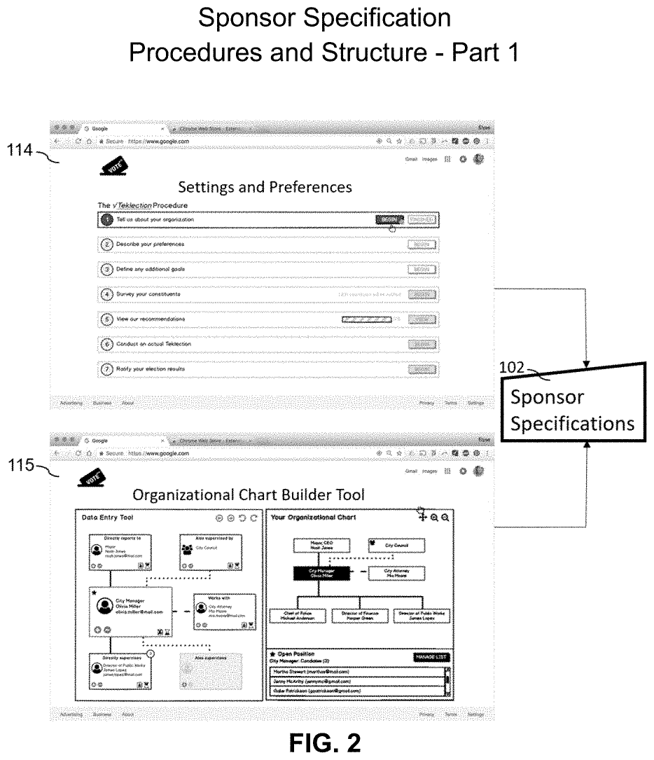

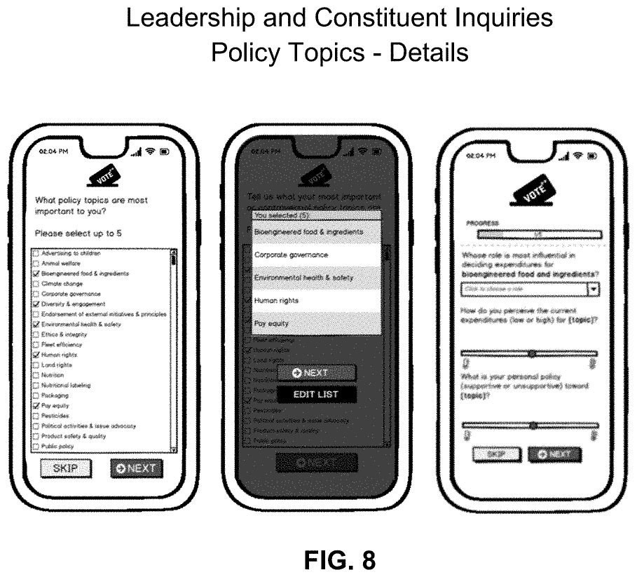

As a software system (FIG. 2-FIG. 11), the process (FIG. 1) may be realized as an online service utilizing the arts of Computer Programming, Web Design, Object Orientation, Client/Server Architecture, Database Theory, Machine Learning and Portable Device Communications and Networking. If sponsored by a government or industry authority it is presumed that a well-known set of eligible participants and regional parameters exist that may inform the system of its extent and available operational methods. For example, while conducting inquiries during the information-gathering phase, a set of eligible participants may be identified and reached by email, physical address, phone survey and/or other appropriate means.

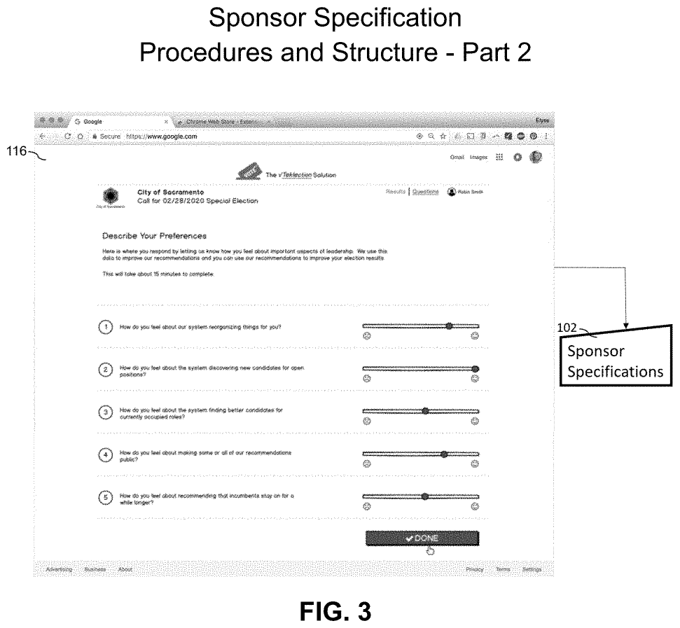

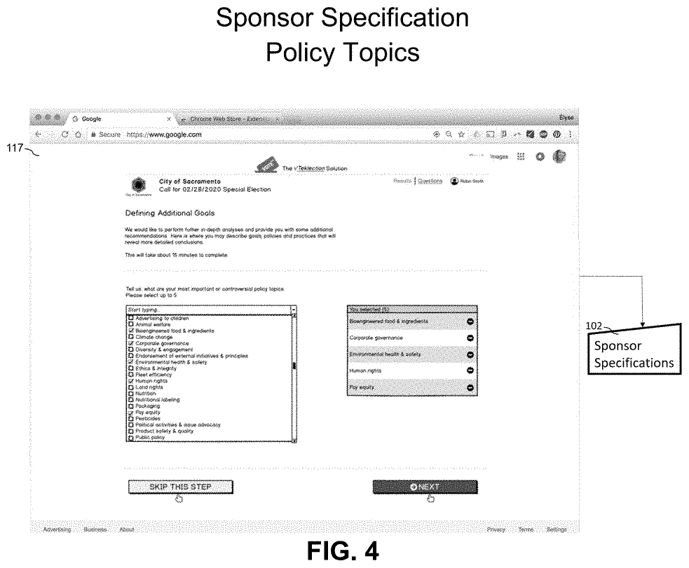

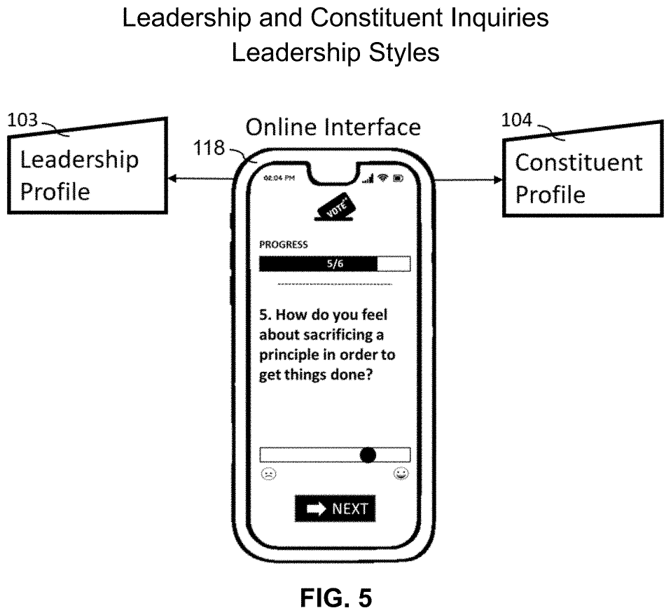

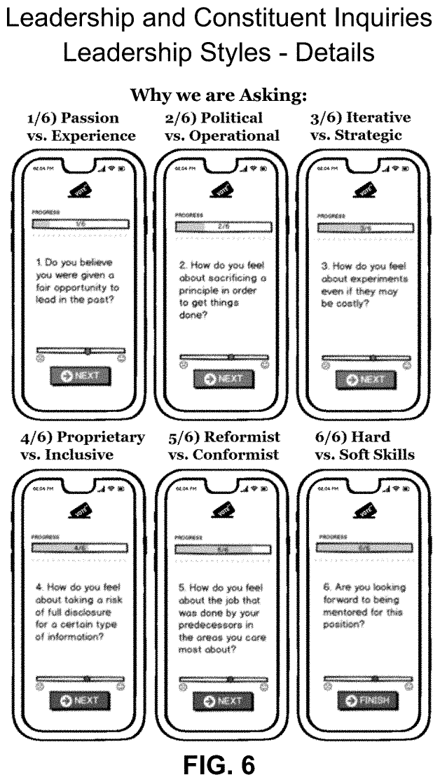

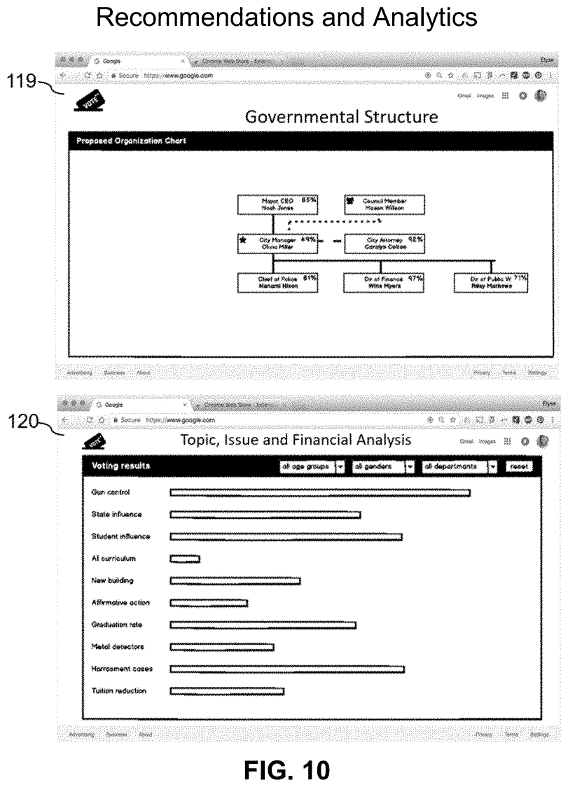

For this online embodiment, a central database server cluster keeps the relational model that defines the roles and links between entity-participants. Attached to the data model are affinity elements (FIG. 1: 103,104/FIG. 5: 103, 104/FIG. 6-FIG. 9) that contribute to an ontology match which produces a number of conclusions and recommendations (FIG. 1: 106/FIG. 10: 119, 120) under parametric influence of the Sponsor configuration (FIG. 1: 102/FIG. 2: 102, 114, 115/FIG. 3: 102, 116/FIG. 4: 102, 117). This specification takes the form of operational parameters that influence data collection and processing to best fit organizational and regional preferences and may also accept influences from prior election cycles belonging to the same Sponsor or different Sponsors worldwide (FIG. 1:113).

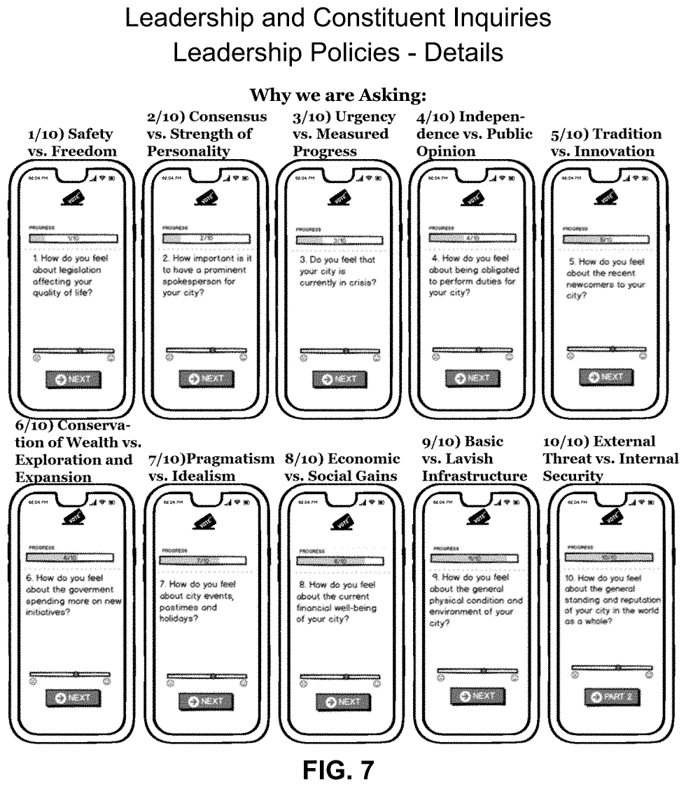

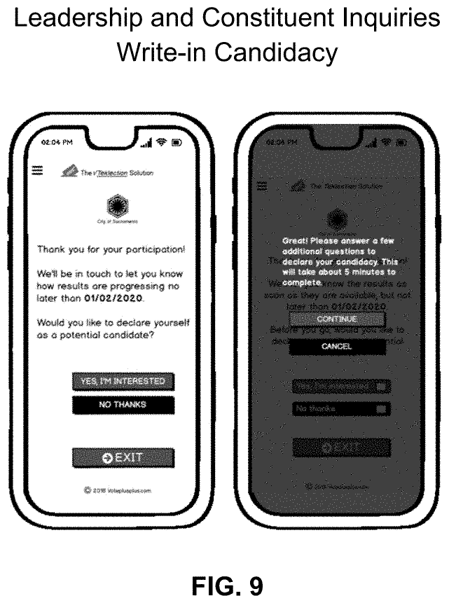

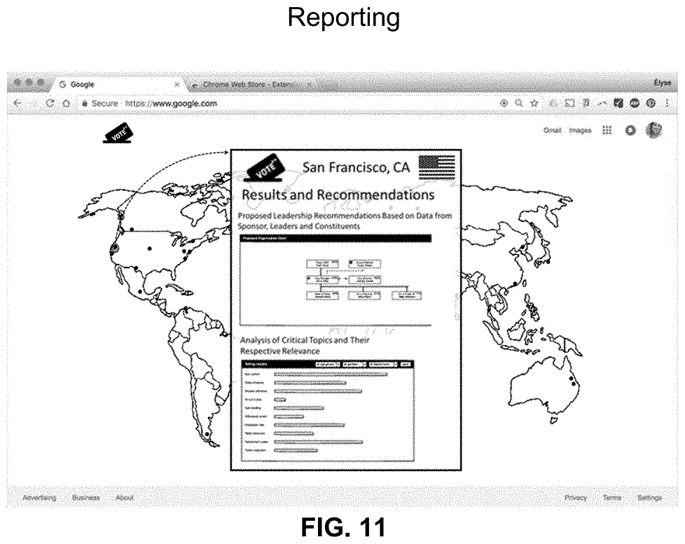

Attributes of the Improved Election Design in One Embodiment (FIG. 1: 106):
Reporting Structure (FIG. 1: 107, 109, 111, 112, 113/FIG. 3/FIG. 11)
Role Assignments (FIG. 1: 102/FIG. 2: 115/FIG. 10: 119)
Position Titles (FIG. 1: 102/FIG. 2: 115)
Write-in Candidates (FIG. 1: 102, 108/FIG. 2: 115/FIG. 9/FIG. 10: 119)
Extension of Incumbent Terms (FIG. 1: 102/FIG. 2: 114, 115)
Candidate Disqualification (FIG. 1: 102/FIG. 2: 114, 115/FIG. 10: 119)
Promotion of Topical Issues and Concerns (FIG. 1: 102/FIG. 2: 114/FIG. 4: 117/FIG. 10:120)
Financial Guidelines (FIG. 1: 102/FIG. 2: 114/FIG. 7/FIG. 10:120)
Election Schedule (FIGS. 1: 101-102/FIG. 2: 114)
   Any election cycle administered within this system may be conducted in accordance with preexisting or established election cycles, regular elections, re-elections, special elections, recalls, referendums, etc.

The data model is populated by receiving data from application user interfaces installed on a variety of personal devices available to participants (FIG. 2: 114,115/FIG. 3: 116/FIG. 4: 117/FIG. 5: 118). Reports are produced from automated recommendations (FIG. 1: 109) and optionally pushed back to the user interfaces of the participants' devices for comparison, subject to Sponsor limitations (FIG. 1: 107,111/FIG. 10: 119, 120). The report data may also be returned back to the specification stage, forming an iterative machine learning cycle and resulting in further refinements in subsequent cycles, if allowed by the Sponsor (FIG. 1: 108). A final set of combined recommendations may be submitted by the Sponsor for ratification in order to conclude the election officially or unofficially (FIG. 1: 110). The ratification process itself may be conducted by the system collecting votes online or submitted to a traditional electoral body, perhaps in order to remain compliant with prevalent conveniences, ceremonies, traditions, legacies and/or lawful procedures. This step concludes a conventional single-cycle election. Nonetheless, this stage is of secondary concern. All cycles may contribute operational reports and findings for intrasystem collection of multiple Sponsor results and/or public viewing and commentary, as permitted by Sponsor configuration (FIG. 1: 112, 113). If an available quorum of reports has been supplied, geopolitical information may be mined and included for influencing subsequent cycles. If voluntarily included, the goal would be to reduce conflict and improve relations between centralized governmental bodies by selecting more compatible Leaders and structures inclined toward diplomacy (FIG. 1: 113). It should be noted that external data may be introduced to influence or supplement direct inquiries and feedback loops at any stage, such as may be provided by social media, historical or legal documents, or news feeds. However, this is an implementation decision for some embodiment and should be weighed against data believability and data provenance. When making direct inquiries and receiving direct responses in a closed system, the data quality will surpass that of unverified or independent sources. With regard to geopolitical forces, the use of external sources may be more acceptable when combined with the Intrasystem Reports Mine (FIG. 1: 113), since relevant statements and reporting tend to arise from a more objective and global perspective, but this is not essential since the system can operate entirely upon its own conclusions as derived from the intrasystem activity of all participating Sponsors worldwide, if available.

The following paragraphs describe the parties who interact with the system, and their respective roles.

Sponsor (a.k.a. Department of Elections, Board of Elections, Election Committee, Corporate Ownership, Corporate Management):

An elections officer or delegated authority, such as Secretary of State, Registrar of Voters, or Supervisor of Elections as in the case of United States national, regional and local elections, or other appointed roles as in the case of world-wide institutions, with whom an appropriate contract can be engaged in order to prescribe use of the system for an election and supervise its configuration. An official electoral process presumably results in the establishment of one or more positions within a governing body that are assigned responsibilities for a segment of a territorial or member electorate. It is therefore possible for the system to be engaged by eligible authorities in the private sector for the purpose of appointing Leadership, as in the case of a Board of Directors, executive management or other corporate positions. It is possible for legislative intervention to occur that will affect system configuration and subsequent ratification methods. It is intended that system processes will be configured to operate in total compliance with all local, regional and national laws, statutes and regulations.

Sponsors may represent governments, corporations, civil groups, or any public or private entity that wishes to mine data from a defined group and optimize their Leadership structure.

Leadership:

One or more individuals aspiring to achieve election or appointment to a role having a decisive influence over operations, management, policy, enforcement, coordination, regulation and other oversight for the benefit of individual contributors within an electorate. Presumably, the types of roles at a level commanding an election also afford Leaders a superior degree of privilege and authority that is intended to facilitate the execution of their responsibilities. Such candidates need not be altruistic, qualified intellectually or academically, or otherwise vetted, yet the system will strive to reveal a maximum degree of compatibility with the constituency using nonjudgmental and objective metrics of Leadership style, financial management and policy positions on topical issues. Once obtained, the system will recommend the most effective and harmonious structure that provides accurate representation, so as to maximize participation and goodwill on both sides. It is presumed that Leadership has its own unique set of individual ideals, responsibilities and mandates (e.g. accountability, transparency, integrity, solicitous concern for the public welfare) and that constituencies have theirs (e.g. compliance, industriousness, regard for law and order, voluntary participation in community programs). The precise nature of these self-defining concepts are undoubtedly influenced by community standard and may be made variable and individualized without diminishing the benefits of the system's conclusions. It is presumed that the resultant knowledge alone, even if the degrees of freedom afforded by the Sponsor configuration are restricted, will have a persistent effect on the course of decision-making for those participating in the pre-election program. Though this corrective influence may be relatively loosely-coupled, merely collecting the information would be considerably better than having none at all. In cases where maximum degrees of freedom are granted to the system for optimization, improvements to the reporting structure, assignment of roles (including write-in candidates) (FIG. 1: 106, 108, 113) and public world-wide reporting (FIG. 11), can assist Leadership in producing timely and properly calibrated change with little or no collateral damage.

Constituent (a.k.a Citizen, Inhabitant, Electorate):

Persons who inhabit a region or institution in which they are legally or otherwise eligible for representation by an organization or government, as may be obtained by citizenship, the right to vote, employment, or other means. In cases where the governmental structure may be oligarchical, the extent of the royal domain will determine the legal standing of citizens who are intrinsically subject to the ruling authority without any specific form of representation. Though less common in the modern world, the results of the invention's pre-election process (with no ratification to follow in this extreme case) still benefits the cause of mutual awareness and understanding on both sides, thereby effecting an indirect form of de facto representation. In the more common cases of pluralism and democracy, there exists a well-known body of Constituents with concomitant rights that afford them specific participation in an electoral process. In such cases, the pre-election process becomes more of a mandate because of its ability to leverage the effort and expense already being applied to conventional campaigning and ratification but produce far better and less costly election outcomes.

Attributes of Leadership and Constituent Profiles in One Embodiment (FIG. 6-FIG. 7):

Passion vs. Experience

Political vs. Operational

Iterative vs. Strategic

Proprietary vs. Inclusive

Reformist vs. Conformist

Hard vs. Soft Skills

Relevant Policy Topics (from an extensive and searchable drop down menu)

Safety vs. Freedom

Consensus vs. Strength of Personality

Urgency vs. Measured Progress

Independence vs. Public Opinion

Tradition vs. Innovation

Conservation of Wealth vs. Exploration and Expansion

Pragmatism vs. Idealism

Economic vs. Social Gains

Basic vs. Lavish Infrastructure

External Threat vs. Internal Security

The results of inquiries (including the ability to enter strength of feeling for each, using a slider model rather than a 1-5, 1-10 or yes/no method of evaluation) are designed to quantify each Leader's and Constituent's attitudes toward the attributes listed above.

In the same logically consistent manner that voting should remain voluntary and never coerced, tampered with, or otherwise corrupted, the pre-election process is intended to be absolutely voluntary for all, from inception to conclusion. Its benefits should serve the common interest of all parties, thereby creating a strong incentive for participation and fulfilling the need for individual self-expression and personal representation. Therefore, it is likely that a sufficient quorum of raw information will be made available for the system to operate successfully.

Regarding all roles and participants, it is intended for the system to detect a threshold of polarization, extremism, volatility, chaos, conflict or other anomalies within or between the Leadership and electorate that may require a postponement, cancelation or modification of the current election cycle until remedial measures can be taken. On rare occasions, this condition may cause the sequence to abort at the Failsafe decision point, (FIG. 1: 105). In addition, data mined from the results of operating the system by other Sponsors, if available, may be allowed to influence this Failsafe decision. For example, escalation of hostilities between rival nations might be detected and taken into account if permitted by a Sponsor's configuration (FIG. 1: 113).

1. A method of collecting, correlating, applying and reporting deep personae data from all participants during an election cycle, both Leadership and Constituencies, under the direction of a certified authority during the pre-election stage, in order to improve the outcome and sustainability of elected governments and other institutions once ultimate ratification occurs:
In accordance with a logical process unspecific to any embodiment an online system, in a practical embodiment utilizing Internet Technologies and Machine Learning, initiates a procedure to collect configuration values from a certified election authority or other authorized agent of a public or private institution, herein known as the Sponsor;
The procedure continues by issuing inquiries designed to solicit meaningful dimensions of persona on a nonjudgmental basis to all participants through online applications on multiple personal devices, with special regard for Leadership styles, preferred organizational structures affected by the election, and topics of interest to all parties including current controversies, policy decisions and financial management, while adhering to parameters imposed by the Sponsor's configuration, such as regional variations;
Responses are delivered to an online server cluster containing a data model and machine learning capabilities;
The server cluster calculates an ontology match based on affinity among personae, adjusts the Sponsor's initial configuration, and reports its recommendations to the Sponsor;
As permitted by the configuration and accepted by the Sponsor, the recommendations are reported back to some or all participants through their online device applications and may contain modifications to the election process, candidate roster, role assignments, role titles and descriptions, new roles to be filled, reporting structure, number of write-in candidates, and other election criteria thereby upgrading awareness of the political nature of the community on all sides and utilizing ontology matching to produce optimizations;
If directed by the Sponsor, the pre-election cycle may be repeated with one or more adopted changes incorporated into the subsequent inquiry, recommendation and reporting procedures;
If directed by the Sponsor, the final results may be submitted for ratification according to a standard, ceremonial or traditional electoral process or conducted online by further utilization of this system or by some other means;
If permitted by the configuration, the before-and-after conditions, along with detailed metrics and visualizations, may be published for intrasystem considerations and/or world-wide observation and critical comparison by the public; and
If a quorum of information exists at the intrasystem reporting stage and permitted by configuration, this data may be mined and incorporated within subsequent cycles for the goal of producing geopolitical stability and improving international relations over time.
